(19) United States
(12) Patent Application Publication
(10) Pub. No.: US 2008/0276991 A1
(43) Pub. Date: Nov. 13, 2008

(54) Preset Flow Control Modules for Dispensing Valves

(75) Inventors: Lawrence B. Ziesel, Woodstock, GA (US); Robert Hughes, Atlanta, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 11/746,193

(22) Filed: May 9, 2007

(51) Int. Cl. F03B 15/02

(52) U.S. Cl. 137/13; 137/561 R

(57) ABSTRACT

A flow controller for fluids. The flow controller may include a flow control chamber, a diffuser positioned within the flow control chamber, and a fixed-length stop. The fixed-length stop is positioned a predetermined distance into the diffuser so as to control the flow rate of the fluids passing through the flow control chamber.

### TECHNICAL FIELD

The present application generally relates to dispensing equipment and, more particularly, but not by way of limitation, to an improved flow controller for regulating the rate of beverage fluid flow associated with a beverage dispenser.

### BACKGROUND OF THE INVENTION

A standard post-mix beverage dispenser mixes beverage fluids to formulate a beverage. Specifically, a supply of concentrate, such as beverage flavored syrup for soft drinks, is mixed with a supply of diluent, such as plain or carbonated water. The concentrate and the diluent are usually dispensed simultaneously through a dispensing nozzle of a dispensing valve assembly such that a desired beverage is both mixed and dispensed to a consumer. Thus, each beverage fluid is brought from a beverage fluid source and across the beverage dispenser to the dispensing valve assembly via a beverage fluid line. The standard post-mix beverage dispenser generally includes, among other mechanisms, a flow controller that controls the quantity and rate of the beverage fluid flow discharged by the dispensing valve assembly.

The flow controller is typically operationally divided into a flow control assembly and a valve assembly. The flow control assembly is linked with and receives beverage fluid from the beverage fluid line. The flow control assembly optimally adjusts the flow rate of the beverage fluid such that a quality drink is discharged from the dispensing nozzle. The valve assembly is operatively engaged with the flow control assembly and the dispensing nozzle so as to permit a desired quantity of beverage fluid to pass from the dispensing valve assembly to the dispensing nozzle.

By maintaining consistent concentrate and diluent flow rates amid varying flow pressures, flow control assemblies in post-mix beverage dispensers ensure that a proper mixture ratio between concentrate and diluent is provided. The proper mixture ratio allows the dispenser to serve beverages with a consistent quality and taste. Such consistency is desired with respect to the marketing and the commercial success of a beverage product. Current flow control assemblies, however, generally require time-consuming initial calibrations by trained technicians to achieve proper concentrate/diluent ratios in the resulting beverage mix. Further, current flow control assemblies routinely require manual recalibration in that they “drift” out of proper adjustment over the course of time

FIG. 1 demonstrates a flow controller 10 according to the prior art, which is described in more detail in U.S. Pat. No. 6,328,181. U.S. Pat. No. 6,328,181 is incorporated herein by reference. The flow controller 10 includes a flow control assembly 20 with a flow control unit 30 with adjustable flow control. As is shown, this unit includes a flow adjustment interface 40 for selectively controlling the flow rate across the flow control unit by varying the position of a piston 50 within a flow control chamber 60. The flow adjustment interface 40 is operatively linked with a flow control spring 70, thereby enabling the piston 50 to be displaced as the flow adjustment interface 40 is displaced. The flow adjustment interface 40 includes an adjustment slot 80 for receiving a corresponding control input (such as a screwdriver) so as to position and adjust the flow adjustment interface 40 (i.e., the flow adjustment interface 40 may be tightened by rotating it clockwise with a screw driver, thereby pushing the piston 50 further into the flow control chamber 60 and decreasing the flow rate allowed by the flow control assembly 20 or the flow adjustment interface may be loosened with opposite results).

Thus, in the example of FIG. 1, a technician is needed to calibrate the assembly at the initial set-up and also may be required to re-calibrate periodically as the device drifts out of proper adjustment. Further, as described in U.S. Pat. No. 6,328,181, it is useful for such flow control assemblies with adjustable flow controls to have a locking unit 90 to prevent anyone but a trained technician to access to the flow control interface 40. This is an attempt to keep the calibration from being detrimentally affected by untrained persons. Nevertheless, the operation of dispensers with adjustable flow controllers has resulted in inconsistent beverage quality and unnecessary labor. Drink integrity may be compromised when flow control assemblies are improperly calibrated, especially by those who are not trained service technicians, or when they drift out of adjustment before a recalibration is performed. Moreover, the required training for the technicians may be time-consuming and costly.

Accordingly, there is a desire for a flow control assembly that provides for accurate and efficient flow rate control for both the concentrate and the diluent streams of a post-mix beverage dispenser. It is further desired that the flow control assembly does not periodically drift out of calibration.

### SUMMARY OF THE INVENTION

The present application thus describes a flow controller for fluids. The flow controller may include a flow control chamber, a diffuser positioned within the flow control chamber, and a fixed-length stop. The fixed-length stop is positioned a predetermined distance into the diffuser so as to control the flow rate of the fluids passing through the flow control chamber.

The fixed-length stop may include a stem and a plug. The stem may include a compressible material such that the stem can be compressed along its longitudinal axis. The compressible material may include a spring. The diffuser may include a hollow cylinder and the plug may include a solid cylinder. The inner radius of the diffuser is slightly larger than the radius of the plug. The diffuser may include a number of diffuser openings.

The flow controller further may include a flow control body that defines the flow control chamber and an interface that detachedly affixes to the flow control body. A fixed portion of the fixed-length stop is affixed to the interface. The fixed-length stop extends a predetermined distance into the flow control chamber.

The fixed-length stop may include a compressible material such that the fixed-length stop can be compressed along its longitudinal axis. The compressible material may include a spring.

The flow controller further may include a number of fixed-length stops with a number of predetermined lengths. When installed, each of the fixed-length stops is positioned a predetermined distance into the diffuser to produce a certain flow rate of the fluids passing through the flow control chamber. The fixed-length stops are color coded according to the predetermined lengths.

The present application further describes a method of controlling the flow rate of a liquid through a flow control chamber. The method may include providing a number of differently sized fixed length stops, determining the desired flow rate of the liquid through the flow control chamber, selecting one of the number differently sized fixed length stops, positioning the selected one of the differently sized fixed length stops within the flow control chamber, and flowing the liquid through the flow control chamber at the desired flow rate.

The present application further describes a flow control chamber for fluids. The flow control chamber may include a diffuser and a number of fixed-length stops with a number of predetermined lengths. When installed, each of the fixed-length stops is positioned a predetermined distance into the diffuser to produce a certain flow rate of the fluids passing through the flow control chamber. The fixed-length stops may be color coded.

These and other features of the present application will become apparent to one of ordinary skill in the art upon review of the following detailed description when taken in conjunction with the drawings and the appended claims,

### BRIEF DESCRIPTION OF THE DRAWINGS

FIG. 1 is an exploded view illustrating an example of a known adjustable flow controller.

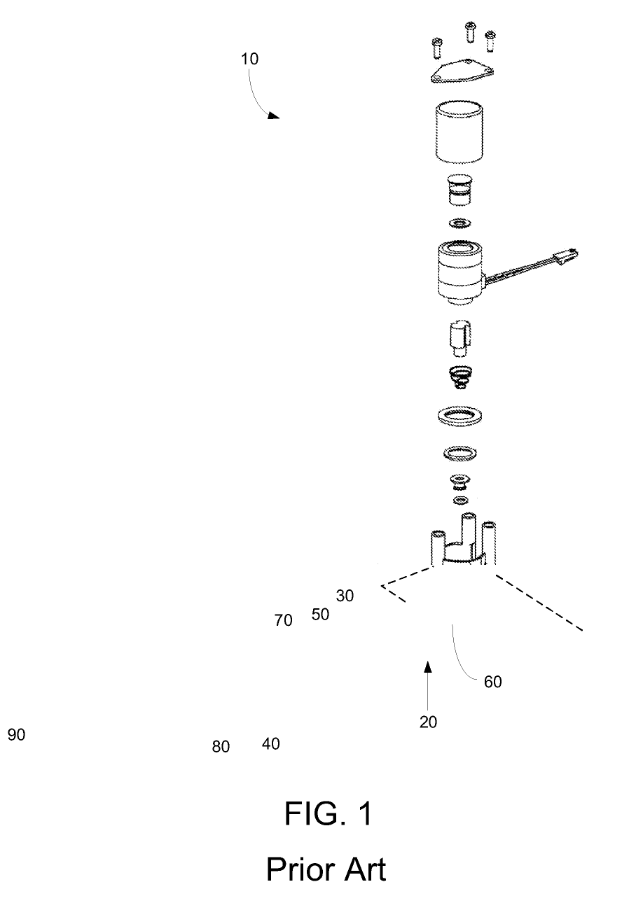

FIG. 2 is an isometric view of a flow controller as is described herein.

FIG. 3 is an exploded view of the flow controller of FIG. 2.

### DETAILED DESCRIPTION

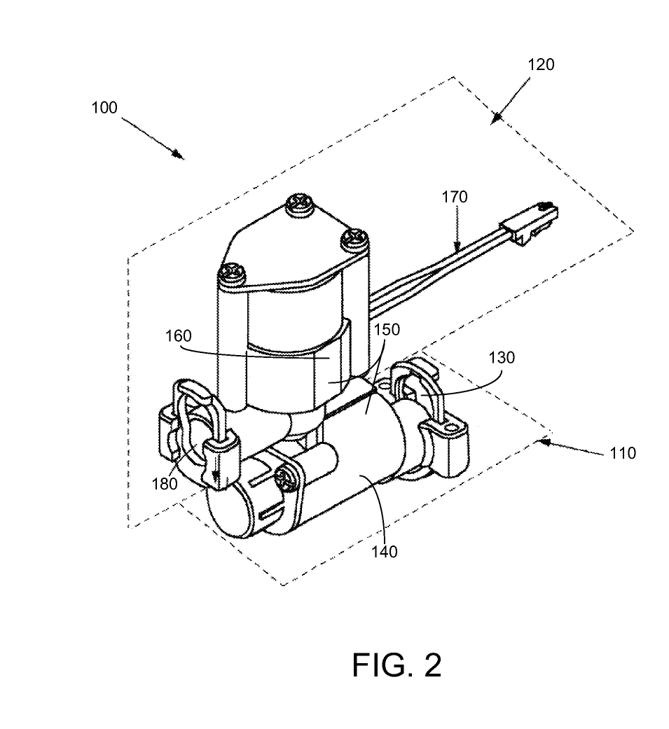

Referring now to the drawings, in which like numerals refer to like elements throughout the several views, FIG. 2 demonstrates a flow controller 100 as is described herein. As described above, the flow controller 100 is contemplated for use with beverage dispenser valve assemblies (not shown) known in the art. As part of one of these beverage dispenser valve assemblies, the flow controller 100 may be linked to and in fluid communication with one or more beverage fluid lines (not shown) so that the flow controller 100 receives beverage fluid, such as post-mix concentrate, post-mix diluent, or pre-mix beverage fluids, from the beverage fluid line. The flow controller 100 may operate to control the quantity and the rate of beverage fluid flow discharged by a dispensing nozzle (not shown) of the beverage dispensing valve assembly.

As shown in FIG. 2, the flow controller 100 may be divided into two portions: a flow control assembly 110 and a valve assembly 120. Generally, the flow control assembly 110 may be operatively linked with and receive beverage fluid from the beverage fluid line. The flow control assembly 110 adjusts the flow rate of the beverage fluid so that a quality drink is discharged from the dispensing nozzle. The valve assembly 120 may be operatively engaged with both the flow control assembly 110 and the dispensing nozzle. The valve assembly 120 thus may permit a desired quantity of beverage fluid to pass from the dispensing valve assembly to the dispensing nozzle.

The flow control assembly 110 may include a manifold inlet 130 and a flow control body 140. The flow control body 140, in turn, is part of a manifold 150. Also part of the manifold 150 may be a valve body 160 of the valve assembly 120. The valve assembly 120 further may include an electric coupling 170 and a manifold outlet 180.

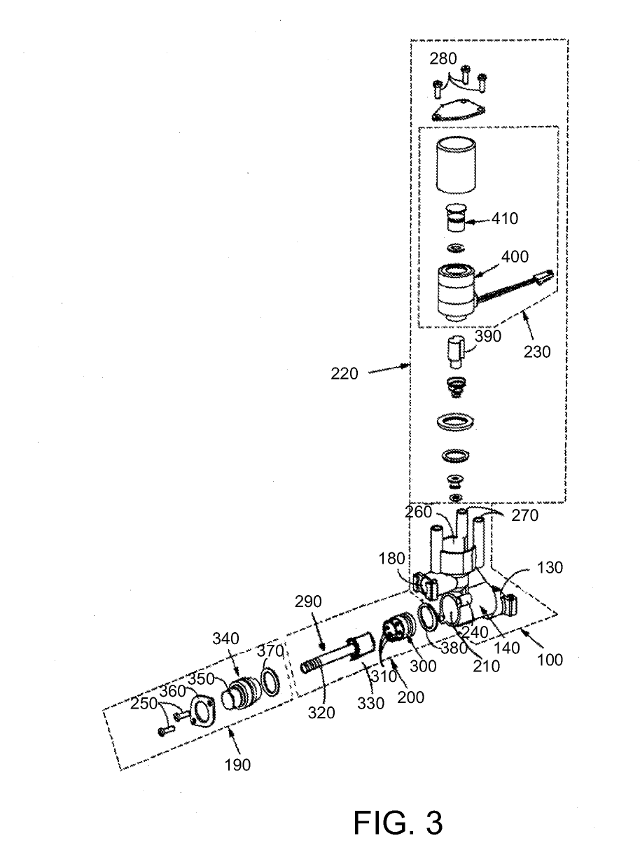

As shown in FIG. 3, the flow control assembly 100 may be further divided into a capping unit 190 and a flow control unit 200. Generally, the flow control unit 200 may maintain a consistent beverage fluid flow rate amid varying flow pressures exerted by the beverage fluid as it is received from the beverage fluid line. The flow controller 100, thus, may establish a favorable flow rate when channeling beverage fluid to the dispensing nozzle in that a favorable flow rate is desired for a beverage dispenser to serve beverages with consistent quality and taste. The capping unit 190 may assist in anchoring the mechanisms of the flow control unit 200, positioning the mechanisms within a flow control chamber 210, and closing the system.

Specifically, the manifold 150 may support and operationally link the flow control assembly 100 and the valve assembly 120. The flow control body 140 may secure the flow control unit 200 and the capping unit 190 thereto. The valve assembly 120 in FIG. 3 may be further apportioned to include an inductor unit 220. The inductor unit 220 may control the quantity of beverage fluid to flow across the flow controller 100 via a coil assembly 230. Thus, in effect, the coil assembly 230 acts as a valve for discharging a desired quantity of beverage fluid. Those of ordinary skill in the art will recognize that this function may be accomplished by other means.

The flow control body 140 may define the flow control chamber 210. The capping unit 190 and the flow control unit 200 may be disposed along the flow control chamber 210. The flow control body 140 further may include at least one anchoring member 240 for threadedly receiving a corresponding flow control screw 250. Although the anchoring member 240 is preferably configured to receive a screw, those of ordinary skill in the art will recognize that the anchoring member 240 can be configured to accommodate any means for attaching the capping unit 190 and the flow control unit 200 along the flow control chamber 210. The manifold inlet 130 may be operatively linked and in fluid communication with the flow control chamber 210 and extend outward from the flow control body 140 for receiving beverage fluid from the beverage fluid line.

In a similar manner, the valve body 160 may secure the inductor unit 220 thereto. The valve body 160 may define a valve chamber 260. The inductor unit 220 may be disposed along the valve chamber 260. The valve body 160 may include at least one anchoring member 270 for threadedly receiving a corresponding valve screw 280.

As stated, the manifold 150 may include the manifold outlet 180 which may be operatively linked with the valve chamber 260 and extend outward from the valve body 160 for discharging beverage fluid from the flow controller 100. Furthermore, the manifold 150 may provide a coupling channel (not shown) for directing beverage fluid from the flow control assembly 110 to the valve assembly 120, thereby operatively linking the flow control assembly 110 and the valve assembly 120.

As illustrated in FIG. 3, the flow control unit 200 may include a fixed-length stop 290 that pushes against beverage fluid entering the flow control chamber 210. In effect, the fixed-length stop 290 may dampen unfavorably high or low pressures associated with the incoming beverage fluid. The flow control unit 200 further may include a diffuser sleeve 300 disposed about the fixed-length stop 290. A number of diffuser outlets 310 may be disposed about the diffuser sleeve 300 to work in conjunction with the fixed-length stop 290 to provide a desired flow rate as beverage fluid passes through the flow control assembly 110 to the valve assembly 120.

The fixed-length stop 290 may include a stem 320 and a plug 330. The stem 320 may be a solid metal cylinder, although other shapes and materials may be used. At one end of the cylinder, the outer surface of the stem 320 may be threaded so that it may be received into a threaded opening. At the other end of the cylinder, the stem 320 may be attached to the plug 330. The plug 330 also may be a solid metal cylinder, although other shapes and materials may be used. The plug 330 may be of larger diameter than the stem 320, although this is not required. The plug 330 may be sized such that it may be inserted into the diffuser sleeve 300, which may include a hollow metal cylinder, although other shapes and materials also may be used. The inner radius of the diffuser sleeve 300 may be slightly larger than the radius of the plug 330. A portion of the stem 320 may be made with a compressible material, such as a spring, such that the fixed-length stop 290 may be compressed along its longitudinal axis during usage, although this alternative is not shown in FIG. 3.

The capping unit 190 may include an interface 340, which may be constructed to engage the fixed-length stop 290. As stated, the stem 320 of the fixed-length stop 290 may be threaded such that it may be received by a threaded opening placed in the interface 340. Those of ordinary skill in the art will recognize that other anchoring means for achieving this purpose are possible. The threaded opening in the interface 340 may be designed to accept a fixed portion of the fixed-length stop 290. Thus, when the fixed-length stop 290 is properly installed in the interface 340 and the interface is properly attached to the flow control chamber 210 (as described in more detail below), the plug 330 will extend into the flow control chamber 210 a predetermined (i.e., known) length.

The interface further may include a knob 350 that may be inserted through a flow control unit retainer 360 that ensures the interface 340 is favorably positioned when it is attached to the flow control body 140. This, in turn, may ensure that the fixed-length stop 290 (which has been threaded into the interface 340 a fixed length) is favorably positioned within the diffuser sleeve 300 and the flow control chamber 210 (as described above). Seals 370 and 380 may be used to prevent seepage of incoming beverage fluid flowing through the flow control chamber 210.

In operation, beverage fluid may flow into the manifold inlet 130 from the beverage fluid line and be directed into the diffuser sleeve 300. The beverage fluid may then encounter the plug 330 disposed within the diffuser sleeve 300 (which is disposed within the flow control chamber 210). Beverage fluid then may flow across the head of the plug 330 and through the space defined by the outer-radius of the plug 330 and the inner-radius of the diffuser sleeve 300. Beverage fluid then may exit this space via the diffuser outlets 310. The positioning of the plug 330 within the diffuser sleeve 300 and in relation to the diffuser outlets 310 may impart a desired flow rate upon the beverage fluid as it passes through this area of the device. At this point, beverage fluid then may be directed through the flow control chamber 210 of the flow control assembly 110 to the valve chamber 260 of the valve assembly 120 via the connecting channel (not shown).

The operation of the valve assembly 120 may allow the beverage fluid to proceed to the dispenser nozzle or may prevent further flow. For example, in a valve closed position, the valve assembly 120 may prevent continued fluid flow. In the valve open position, such as when a desired drink is required to be dispensed from the beverage dispenser, the valve assembly 120 may allow the beverage fluid to flow through the unit. Although this function may be accomplished by several means known in the art, the example shown in FIG. 3 demonstrates the inductor unit 220 having a plunger 390, disposed in the valve chamber 260 and operatively linked with the coil assembly 230 for selectively restricting beverage fluid flow to the manifold outlet 180. The coil assembly 230 may include a coil element 400 and an actuator element 410 operatively linked with the coil element 400, whereby the coil element 400 and the actuator element 410 act in cooperation for selectively controlling the position of the plunger 390 so as to restrict beverage fluid flow. Thus, when a desired drink is required to be dispensed from a beverage dispenser, an electric current may be sent through the coil element 400 so as to magnetize the actuator element 410. The actuator element 410, in turn, may impart an electromotive force on the plunger 390 causing it to lift and expose an open passageway to permit fluid flow to the manifold outlet 180, which may then be discharge through the nozzle. In this manner, the valve assembly 120 may control the quantity of beverage released at the dispenser nozzle.

Thus, beverage fluid may be delivered in a desired quantity at a controlled and constant rate of flow. As such, two or more such flow controllers 100 may be used to furnish a mixed beverage (i.e., a beverage that requires the mixture of one or more liquid beverage ingredients) with a consistent ratio of the required ingredients. This may be accomplished by using appropriately sized fixed-length stops 290 in each of the flow controllers 100. More particularly, each flow controller 100 may be fitted with a particular fixed-length stop 290 (that may be of a different length than the other fixed-length stops 290) such that the combined effect (because of the particular flow rates each fixed-length stop 290 produces in the liquid beverage ingredient of its respective flow controller) yields the proper ingredient ratio in the mixed beverage.

For example, beverage “Z” may include a mixture of beverage ingredient “X” and beverage ingredient “Y.” Further, for the sake of this simplified example, the appropriate ratio of X and Y in beverage Z may be 60% X and 40% Y. Thus, it is necessary that the flow controllers 100 have consistent and particular flow rates in relation to each other such that they yield substantially the proper ratio in the resulting beverage mixture. With this in mind, a number of fixed-length stops 290 may be constructed such that a spectrum of fixed lengths is covered at certain length intervals, i.e., a set of fixed-length stops 290 may be created. The different lengths of the fixed-length stops 290 thus may represent different flow rates for a particular beverage ingredient (or different flow rates for a group of similar beverage ingredients that have substantially the same physical properties that are relevant to flow rate, such as density, viscosity, etc.). Each fixed-length stop 290 in the set, upon installation, may result in a different position of the plug 330 in the diffuser sleeve 300 and, thus, a different flow rate of a particular beverage ingredient through the device.

The stops 290 may be color coded depending upon the desired flow rate, i.e., a red stop 290 would have one flow rate, a green stop 290 would have a different one, etc. The stops 290 may accommodate a wide range of fluids and fluid characteristics.

Continuing with the current example, the flow rate of beverage ingredient X through the flow control unit 200 may be tested using each of the fixed-length stops 290 of the set. Likewise, the flow rate of beverage ingredient Y through the flow control unit 200 may be tested using each of the fixed-length stops 290 of the set. The results of the testing may be used to determine which combination of fixed-length stops 290 yields the favorable 60-40 mixture for beverage Z. In the field, the two relevant fixed-length stops may be efficiently installed by simply inserting them into the interface 340. Henceforth, each time beverage Z is desired in a beverage dispenser, this known fixed-length stop 290 combination may be conveniently employed. Further, use of the fixed-length stops 290 means the flow rates will not “drift” during use, which will provide for a more consistent flow rate and eliminate the need for recalibration.

It should be apparent that the foregoing relates only to the preferred embodiments of the present application and that numerous changes and modifications may be made herein without departing from the general spirit and scope of the invention as defined by the following claims and the equivalents thereof.

I claim:

1. A flow controller for fluids, comprising:
a flow control chamber;
a diffuser that is positioned within the flow control chamber; and
a fixed-length stop;
wherein the fixed-length stop is positioned a predetermined distance into the diffuser so as to control the flow rate of the fluids passing through the flow control chamber.

2. The flow controller of claim 1, wherein the fixed-length stop comprises a stem and a plug.

3. The flow controller of claim 2, wherein the stem comprises a compressible material such that the stem can be compressed along its longitudinal axis.

4. The flow controller of claim 3, wherein the compressible material comprises a spring.

5. The flow controller of claim 2, wherein the diffuser comprises a hollow cylinder and the plug comprises a solid cylinder.

6. The flow controller of claim 5, wherein the inner radius of the diffuser is slightly larger than the radius of the plug.

7. The flow controller of claim 1, wherein the diffuser comprises a plurality of diffuser openings.

8. The flow controller of claim 1, further comprising:
a flow control body that defines the flow control chamber; and
an interface that detachedly affixes to the flow control body.

9. The flow controller of claim 8, wherein a fixed portion of the fixed-length stop is affixed to the interface.

10. The flow controller of claim 9, wherein the fixed-length stop extends a predetermined distance into the flow control chamber.

11. The flow controller of claim 1, wherein the fixed-length stop comprises a compressible material such that the fixed-length stop can be compressed along its longitudinal axis.

12. The flow controller of claim 11, wherein the compressible material comprises a spring.

13. The flow controller of claim 1, further comprising:
a plurality of fixed-length stops comprising a plurality of predetermined lengths;
wherein each of the fixed-length stops is positioned a predetermined distance into the diffuser to produce a certain flow rate of the fluids passing through the flow control chamber.

14. The flow controller of claim 13, wherein the plurality of fixed-length stops are color coded according to the plurality of predetermined lengths.

15. A method of controlling the flow rate of a liquid through a flow control chamber, comprising:
providing a plurality of differently sized fixed length stops;
determining the desired flow rate of the liquid through the flow control chamber;
selecting one of the plurality differently sized fixed length stops;
positioning the selected one of the differently sized fixed length stops within the flow control chamber; and
flowing the liquid through the flow control chamber at the desired flow rate.

16. A flow control chamber for fluids, comprising:
a diffuser that is positioned within the flow control chamber; and
a plurality of fixed-length stops comprising a plurality of predetermined lengths;
wherein each of the fixed-length stops is positioned a predetermined distance into the diffuser to produce a certain flow rate of the fluids passing through the flow control chamber.

17. The flow control chamber of claim 16, wherein the plurality of fixed length stops are color coded.
